(19) United States
(12) Patent Application Publication
(10) Pub. No.: US 2011/0027532 A1
(43) Pub. Date: Feb. 3, 2011

(54) SURFACE MODIFIED ELECTRICAL INSULATION SYSTEM

(75) Inventors: Lars E. SCHMIDT, Zurich (CH); Bandeep Singh, Wytheville, VA (US); Stephen Clifford, Bremgarten (CH); Stephane Schaal, Sierentz (FR)

Correspondence Address: BUCHANAN, INGERSOLL & ROONEY PC, POST OFFICE BOX 1404, ALEXANDRIA, VA, 22313-1404, US

(73) Assignee: ABB RESEARCH LTD, Zuerich (CH)

(21) Appl. No.: 12/854,686

(22) Filed: Aug. 11, 2010

Related U.S. Application Data
(63) Continuation of application No. PCT/EP2008/051656, filed on Feb. 12, 2008.

(51) Int. Cl. B32B 3/10; B05D 3/12

(52) U.S. Cl. 428/142; 427/289

(57) ABSTRACT

A surface modified electrical insulation system having a super hydrophobic surface, the insulation system having a hardened or cured synthetic polymer composition which contains at least one filler material and optionally further additives. The at least one filler material can be selected from a group of filler materials containing inorganic oxides, inorganic hydroxides and inorganic oxyhydroxides. The surface of the electrical insulation system can be formed as a structured surface with micro-scale and nano-scale features, whereby the surface is covered with a liquid hydrophobic compound.

### RELATED APPLICATION

This application claims priority as a continuation application under 35 U.S.C. §120 to PCT/EP2008/051656 filed as an International Application on Feb. 12, 2008 designating the U.S., the entire content of which is hereby incorporated by reference in its entirety.

### FIELD

Surface modified electrical insulation systems are disclosed which can include a selected filler material containing a synthetic polymer composition, the surface of the electrical insulation system being super hydrophobic. Methods of producing the surface modified electrical insulation system having a super hydrophobic surface are also disclosed.

### BACKGROUND INFORMATION

Outdoor electrical insulations are known which include a hydrophobic surface which allows dirt and pollution deposited on the surface to be removed by rain, resulting in a self-cleaning effect. Such self-cleaning surfaces are made for example from silicone rubber or hydrophobic cycloaliphatic epoxy resin compositions. These materials are classed as hydrophobic meaning that they have a surface contact angle with water within a range of, for example, about 90°-140°. The efficiency of this self-cleaning effect can be increased by increasing the surface contact angle with water further to be higher than 140°. A surface having a surface contact angle with water higher than 140° has been referred to as a super hydrophobic surface. It is known to achieve these high surface contact angles by applying a so called Lotus Effect coating to the insulation material. In order to obtain a super hydrophobic surface, the outermost surface layer is hydrophobic and the layer is structured in a micro- or nano-range thickness.

WO 2006/044642, the disclosure of which is hereby incorporated by reference in its entirety, discloses a method of applying Lotus Effect materials as a super hydrophobic protective coating for external electrical insulation system applications. The Lotus effect material deposited forms a secondary coating as an additional layer on the substrate material whereby the substrate material has no influence on the surface properties provided by the secondary coating material. With a secondary coating, durability of the coated material can be dependent on the level of adhesion of the coating to the substrate. The properties of the coating, for example the dielectric behavior and the UV-stability, will inevitably differ from those of the substrate. To address these issues, WO 2006/044642 proposes to add UV stabilizers and flame retardants to the Lotus Effect material.

### SUMMARY

A surface modified electrical insulation system is disclosed, comprising: a hardened or cured synthetic polymer composition which contains a synthetic polymer having at least one of an electrically insulating thermoplastic polymer and an electrically insulating duroplastic polymer, and which contains at least one filler material having at least one of an inorganic oxide, an inorganic hydroxide and an inorganic oxyhydroxide, the at least one filler material being present in the insulation system in an amount within a range of about 60% to 80% by weight calculated to a total weight of the insulation system; and a surface formed as a structured surface with micro-scale and nano-scale features, said structured surface being covered with a liquid hydrophobic compound.

A method of producing a surface modified electrical insulation system is disclosed, comprising: (i) providing a hardened or cured synthetic polymer composition including at least one filler; (ii) treating a surface of the electrical insulation system so that a structured surface is formed with micro-scale and nano-scale features; and (iii) covering said structured surface with a liquid hydrophobic compound, or with a self-assembled monolayer (SAM) composed from at least one amphiphilic compound; or with a self-assembled monolayer (SAM) composed from at least one amphiphilic compound combined with a liquid hydrophobic compound.

An electrical article having a surface modified electrical insulation system is disclosed, comprising: a hardened or cured synthetic polymer composition which contains a synthetic polymer having at least one of an electrically insulating thermoplastic polymer and an electrically insulating duroplastic polymer, and which contains at least one filler material having at least one of an inorganic oxide, an inorganic hydroxide and an inorganic oxyhydroxide, the at least one filler material being present in the insulation system in an amount within a range of about 60% to 80% by weight calculated to a total weight of the insulation system; and a surface formed as a structured surface with micro-scale and nano-scale features, said structured surface being covered with a liquid hydrophobic compound.

### DETAILED DESCRIPTION

Methods are disclosed herein for producing a surface of an electrical insulator which exhibits the Lotus Effect and at the same time has substantially the same properties, for example the dielectric behavior and UV-stability, as a bulk material of the electrical insulator. Further, interface issues caused by a separate coating can be eliminated. According to exemplary methods, the surface of the insulator can be treated so that a “structured surface” of the insulator is obtained. A structured surface means that the surface is in a native state; that is, the surface of the insulator is present with its micro-scale and nano-scale features. These features are used for producing therefrom the Lotus Effect according to the present disclosure.

A structured surface of an insulator material can be obtained, for example, by sand-blasting the surface of the substrate material. The structured surface of the insulator material is treated with a liquid hydrophobic compound. Such liquid hydrophobic compound may be for example a liquid polysiloxane, whereby a thin layer of the hydrophobic compound is formed on the surface, the surface thereby becoming super hydrophobic. The liquid hydrophobic compound further may be an amphiphilic compound whereby the structured surface of the insulator material is treated with the amphiphilic compound for a time long enough until a self-assembled monolayer (SAM) surface is formed. Also a combined treatment of the structured surface is possible; that is, the structured surface is treated with an amphiphilic compound and subsequently with a liquid hydrophobic compound, for example a liquid polysiloxane.

The treatment with a liquid hydrophobic compound, such as a liquid polysiloxane, can be achieved either by treating the structured surface directly with the hydrophobic compound or by incorporating the hydrophobic additive into the substrate, or by combining both methods. The liquid hydrophobic material can diffuse from the inside of the insulator composition to the surface of the insulator and form a thin layer of the liquid hydrophobic material on the structured surface rendering said surface super hydrophobic.

An exemplary feature of embodiments disclosed herein is that the insulation material can contain an inorganic filler such as silica or alumina which is at least partly exposed to the surface and is put in its native form by the sand-blasting process.

Self-assembled monolayers (SAM) are formed from so called amphiphilic molecules, that is of molecules which prefer a different chemical surrounding on either end of the molecule. Examples are compounds, resp. molecules, which on one end are water repellent (that is, are hydrophobic by having a water repellent end group), and on its other end are hydrophilic, by having an affinity to water. By applying self-assembled monolayers (SAM) to a surface, the surface properties such as the surface energy can be altered and a hydrophilic surface can thereby be transformed into a hydrophobic surface.

Thus, a surface modified electrical insulation system having a super hydrophobic surface is disclosed, the insulation system having a hardened or cured synthetic polymer composition which contains at least one filler material and optionally further additives, wherein:
(i) the synthetic polymer is selected from electrically insulating thermoplastic and duroplastic polymers;
(ii) the at least one filler material is selected from the group of filler materials comprising inorganic oxides, inorganic hydroxides and inorganic oxyhydroxides,
(iii) the at least one filler material is present in the insulation system in an amount within an exemplary range of about 60% to 80% (or lesser or greater) by weight calculated to the total weight of the insulation system; and
(iv) the surface of the electrical insulation system is present in the form of a structured surface with its micro-scale and nano-scale features, whereby the structured surface has been covered with a liquid hydrophobic compound.

An exemplary liquid hydrophobic compound with which the structured surface of the electrical insulation system has been covered or treated, resp. which is covering the structured surface of the electrical insulation system can be selected from liquid organopolysiloxanes, and preferably selected from, for example, cyclic organopolysiloxanes and/or low molecular weight oligomeric organopolysiloxanes. Further, the structured surface covered with a liquid hydrophobic compound may be covered with a self-assembled monolayer (SAM) composed from at least one amphiphilic compound, wherein the self-assembled monolayer (SAM) optionally may be additionally covered with a liquid hydrophobic compound.

Exemplary methods of producing the surface modified electrical insulation system having a super hydrophobic surface are also disclosed. The surface modified electrical insulation system can be included as an insulation system in electrical articles. That is, the electrical articles can be produced which include the disclosed surface modified electrical insulation system.

A surface modified electrical insulation system according to the present disclosure can include a hardened or cured synthetic polymer composition. The polymer may be selected from polymers known in the art of being used in electrical insulator compositions, such as polyesters, for example poly(methyl-methacrylate), or poly(alkylacrylonitrile), or duroplastic polymers such as polyurethanes or epoxy resin compositions. Exemplary preferred polymers are epoxy resin compositions, such as cycloaliphatic epoxy resin compounds. The epoxy resin compositions can contain the epoxy resin, a hardener, a curing agent to accelerate the curing process, as well as further additives. These compounds are known per se.

Cycloaromatic and cycloaliphatic epoxy resin compounds may be used. Exemplary preferred compounds are cycloaliphatic epoxy resin compounds. Such epoxy resin compounds can contain at least two 1,2-epoxy groups per molecule. Epoxy resin compounds useful for exemplary embodiments are unsubstituted glycidyl groups and/or glycidyl groups substituted with methyl groups. These glycidyl compounds have an epoxy value (equiv./kg) of, for example, at least three, preferably at least four and especially at about five or higher (e.g., about 5.0 to 6.1). For example, optionally substituted epoxy resins of formula (I) can be used:

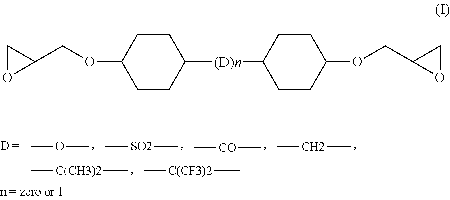

Compounds of formula (I) wherein D is —(CH₂)— or [—C(CH₃)₂—] are exemplary preferred compounds. Further cycloaliphatic epoxy resins to be used within the scope of the disclosure are for example hexahydro-o-phthalic acid-bis-glycidyl ester, hexahydro-m-phthalic acid-bis-glycidyl ester or hexahydro-p-phthalic acid-bis-glycidyl ester. Exemplary preferred cycloaliphatic epoxy resin compounds are liquid at room temperature or when heated to a temperature of up to about 65° C. Exemplary preferred cycloaliphatic epoxy resin compounds are for example Araldite® CY 184 (Huntsman Advanced Materials Ltd.), a cycloaliphatic epoxy resin compound (diglycidylester) having an epoxy content of 5.80-6.10 (equiv/kg) or Araldite® CY 5622 (Huntsman Advanced Materials Ltd.), a modified epoxy resin compound (diglycidylester) having an epoxy content of 5.80-6.10 (equiv/kg). Araldite® CY 5622 is a hydrophobic cycloaliphatic epoxy formulation for hydrophobicity transfer and recovery in outdoor epoxy resin compositions. A hydrophobic cycloaliphatic epoxy formulation means that the filler material has been pre-treated with a silane or a silane additive has been added to the composition.

The epoxy resin composition to be cured can include the epoxy resin, the hardener and the curing agent. Hardeners are for example hydroxyl and/or carboxyl containing polymers such as carboxyl terminated polyester and/or carboxyl containing acrylate- and/or methacrylate polymers and/or carboxylic acid anhydrides. Useful hardeners also include aliphatic, cycloaliphatic polycarbonic acids. Exemplary preferred anhydrides are liquid cycloaliphatic anhydrides with a viscosity at 25° C. of about 70-80 mPa s. Such a liquid cycloaliphatic anhydride hardener is for example Aradur® HY 1235 (Huntsman Advanced Materials Ltd.). The optional hardener can be used in concentrations within the range of 0.2 to 1.2, equivalents of hardening groups present (e.g., one anhydride group per 1 epoxide equivalent).

The inorganic filler has an average grain size as known for the use in electrical insulation systems and is, for example, within range of 1 μm (micron) up to 3 mm. An exemplary preferred average grain size is within a range of about 5 μm to 300 μm (or lesser or greater), preferably from 10 μm to 100 μm, or a selected mixture of such average grain sizes. An exemplary preferred filler material can possess a high surface area.

The filler material can be selected from filler materials which have a structured surface after sand-blasting. It has been found that such a structured surface has surprisingly strong binding forces towards the liquid hydrophobic compound. The structured surface is also able to chemically react with the hydrophilic end of an amphiphilic molecule so that a self-assembled monolayer (SAM) is formed. For achieving this effect, the mineral filler can, for example, be selected from the group of filler materials comprising inorganic oxides, inorganic hydroxides and inorganic oxyhydroxides, preferably silica, quartz, known silicates, aluminium oxide, aluminium trihydrate [ATH] and titanium oxide. exemplary fillers are silica, quartz, aluminium oxide and aluminium trihydrate [ATH], preferably silica, aluminium oxide and aluminium trihydrate [ATH] and preferably silica. The filler materials, can have a minimum SiO₂-content, resp. a minimum Al₂O₃-content, of about 95-98% by weight, preferably of about 96-98% by weight.

The inorganic filler is present in the synthetic polymer composition within an exemplary range of about 60% by weight to about 80% by weight, for example within the range of about 60% by weight to about 70% by weight, and preferably at about 65% by weight, calculated to the total weight of the synthetic polymer composition.

The surface of the electrical insulation system is present as a structured surface in its native state with its micro-scale and nano-scale features. Such a structured surface can be made by sand-blasting the surface of the insulation until substantially all the micro and nano-scale features are formed.

According to an exemplary embodiment of the present disclosure, the surface of the electrical insulation system being present in the form of a structured surface is covered with a liquid hydrophobic compound. Such liquid hydrophobic compound is, for example, selected from liquid organopolysiloxanes, preferably from cyclic organopolysiloxane and/or low molecular oligomeric organopolysiloxane.

The liquid hydrophobic compound as a cyclic organopolysiloxane is composed of units of the chemical formula —[Si(R)(R)O]—, which form a ring composed with, for example, 4 to 12 such units. Such cyclic organopolysiloxane can be a mixture of such cyclic compounds as is known to those skilled in the art. For example, cyclic organopolysiloxanes with 4 to 8 such organosiloxy units can be included. The substituent R in formula —[Si(R)(R)O]— refers to independent of each other linear, branched or cyclic alkyl or phenyl, the alkyl residue having, for example, 1 to 8 carbon atoms, optionally being substituted by chlorine and/or fluorine; preferably phenyl, (C₁-C₄)-alkyl which optionally is substituted by fluorine; preferably phenyl, 3,3,3-trifluoropropyl, monofluoromethyl, difluoromethyl, trifluoromethyl, or unsubstituted (C₁-C₄)-alkyl; preferably methyl.

The liquid hydrophobic compound as a low molecular oligomeric organopolysiloxane can be composed of units of the chemical formula —[Si(R)(R)O]—, which are end-stopped by terminal endgroups of the formula —OSi(R)₃—, wherein R has the meaning as given for the substituent R in cyclic polysiloxane compounds herein above. Low molecular liquid oligomeric organopolysiloxanes can represent a mixture of such compounds and may contain up to 50 units of —[Si(R)(R)O]—, preferably about 8 to 20 such units. This is known to those skilled in the art.

The liquid hydrophobic compound may be added to the structured surface as such without a solvent or be dissolved in a suitable solvent such as any organic solvent, for example, an aliphatic hydrocarbon with low boiling point, and be applied to the structured surface of the electrical insulation system whereby the solvent subsequently is evaporated. The liquid hydrophobic compound is applied in a quantity so that a layer with a thickness within the nano range or micro range is formed.

The liquid hydrophobic compound can be incorporated into the bulk of the electrical insulator system. The liquid hydrophobic compound is then able to diffuse from the bulk to the structured surface of the insulator yielding a super hydrophobic surface as well as hydrophobicity recovery. In this case, a separate addition of the hydrophobic compound to the surface is recommended, however, not necessary. The amount of the liquid polysiloxane compound, when incorporated into the bulk of the insulator system is within an exemplary range of 0.1% to 5% by weight, preferably 0.5% to 5% and especially about 1% by weight, calculated to the total weight of the insulator composition.

In an exemplary embodiment, the liquid hydrophobic compound is incorporated into the bulk of the electrical insulator system. The surface of the insulator is then sand-blasted to yield a structured surface. To the structured surface of the electrical insulation system, a liquid hydrophobic compound is applied so that said surface becomes covered with a thin layer of said liquid hydrophobic compound.

In a further exemplary embodiment, the liquid hydrophobic compound is incorporated into the bulk of the electrical insulator system. The surface of the insulator is then sand-blasted to yield a structured surface. The structured surface of the electrical insulation system is then covered with a self-assembled monolayer (SAM) composed from at least one amphiphilic compound as described herein above. Optionally a liquid hydrophobic compound is subsequently applied to the surface of the electrical insulation system which has been pretreated with a self-assembled monolayer.

An exemplary structured surface of the electrical insulation system, therefore, may either be covered with a liquid hydrophobic compound; or be covered with a self-assembled monolayer (SAM) composed from at least one amphiphilic compound; or be covered with a self-assembled monolayer together with a liquid hydrophobic compound. The self-assembled monolayers have a thickness within the nano-range or micro range, which is known per se; the thin coat being electrically non-conductive.

Self-assembled monolayers (SAM) can be either grown from solution or from the gas-phase. The reactive group of the amphiphilic compound chemically reacts with the structured surface of the insulator material thereby forming the self-assembled monolayer. According to exemplary embodiments, silane-based self-assembled monolayers as obtained from alkyltrichlorosilanes are preferred. Also preferred are self-assembled monolayers as obtained from (C₄-C₂₂)-alkyltrichlorosilanes, preferably from (C₁₂-C₂₂)-alkyltrichlorosilanes, for example from octadecyltrichlorosilane (OTS). These silanes chemically bind to hydroxylated surfaces such as hydroxylated silica (SiO₂) or epoxy resin compositions having free reactive groups such as hydroxyl groups by splitting off the chlorine atoms and forming Si—O—Si bonds, which results in a self-assembled monolayer being super hydrophobic.

If the self-assembled monolayer is formed from solution various carrier solvents can be used. Exemplary carrier solvents for the mentioned trichlorosilanes are anhydrous organic solvents, such as benzene, toluene, bicyclohexyl, 2,2,4-trimethylpentane or related solvents.

If the self-assembled monolayer is formed from the gaseous phase (e.g., by chemical vapor deposition), the surface to be treated is for example put into a vacuum chamber at room temperature together with a vessel containing the silane compound (e.g. the octadecyltrichlorosilane (OTS)). The pressure is then decreased below the vapor pressure of OTS, for example to 6.7 mbar (at room temperature). After a period of about 24 hours full surface coverage (i.e., the self-assembled monolayer) is obtained.

Optional additives to the composition may further comprise, for example, a curing agent (accelerant) for enhancing the polymerization of the epoxy resin with the hardener. Further additives may be selected from wetting/dispersing agents, flexibilizers, plasticizers, antioxidants, light absorbers, pigments, flame retardants, fibers and other additives generally used in electrical applications. These are known to those skilled in the art and need not be further described in detail.

A method is disclosed of producing a surface modified electrical insulation system having a super hydrophobic surface, the insulation system including a hardened or cured synthetic polymer composition which contains at least one filler material and optionally further additives, comprising the following steps: (i) providing a hardened or cured synthetic polymer composition including at least one filler and optionally further additives, as defined herein above; (ii) treating the surface of the electrical insulation system so that a structured surface with its micro-scale and nano-scale features is formed, (e.g., by sand-blasting the surface); and (iii) covering the structured surface with a liquid hydrophobic compound; or with a self-assembled monolayer (SAM) composed from at least one amphiphilic compound; or covering said surface with a self-assembled monolayer (SAM) composed from at least one amphiphilic compound and a liquid hydrophobic compound.

Exemplary uses of the surface modified electrical insulation system as disclosed herein are in power transmission and distribution applications, such as electrical insulations, especially in the field of impregnating electrical coils and in the production of electrical components such as transformers, embedded poles, bushings, high-voltage insulators for indoor and outdoor use, especially for outdoor insulators associated with high-voltage lines, as long-rod, composite and cap-type insulators, sensors, converters and cable end seals as well as for base insulators in the medium-voltage sector, in the production of insulators associated with outdoor power switches, measuring transducers, lead-throughs, and over-voltage protectors, in switchgear construction. The following examples illustrate embodiments as disclosed herein.

### Example 1

### (A) Substrate Manufacture

The cycloaliphatic epoxy (CEP) formulation used as the insulator material in this example is given in Table 1. All components, except the catalyst, were pre-heated to 45° C. These were then intensively mixed together at ambient pressure with a propeller mixer. The complete mixture was then degassed in a vacuum oven, with mixing, at about 5 mbar, for 20 minutes at 60° C. The mixture was then molded into 6 mm thick plates using steel moulds pre-heated to 90° C. and coated with Huntsman QZ13 mould-release agent. A curing cycle of 2 hours at 90° C., followed by 24 hours at 140° C., was applied to ensure complete curing. The surface contact angle of this silica-filled cycloaliphatic epoxy material between the structured surface and water was measured after sand-blasting and cleaning from any dust and was found to be below 90°.

TABLE 1

| Components | phr |
|---|---|
| Huntsman CY 184 (resin) | 100 |
| Huntsman HY1235 (hardener) | 90 |
| Huntsman DY062 (catalyst) | 0.54 |
| Huntsman DW9134 (pigment, TiO₂) | 2.7 |
| Quarzwerke W 12EST (filler) | 359 |

Araldite® CY 184: Cycloaliphatic epoxy resin (Huntsman)
Aradur®HY1235: modified cycloaliphatic anhydride (Huntsman)
Accelerator DY062: liquid tertiary amine

### W12 EST: SiO₂ (Quarzwerke GmbH)

### (B) Sand-Blasting and Treatment with Octadecyltrichlorosilane

The cured cycloaliphatic epoxy resin insulation material prepared in this Example 1, Chapter (A), was sand-blasted and cleaned from any remaining dust. The obtained structured surface was then treated by immersing it in a solution of octadecyltrichlorosilane (OTS) in bicyclohexyl with a concentration of 4 mMol per liter of bicyclohexyl, at ambient temperature and pressure, under an argon atmosphere, for 24 hours, so that a self-assembled mono-layer which was chemically bonded to the exposed surface was formed. The resulting surface had a surface contact angle to distilled water of greater than 140°.

### Example 2

Cured hydrophobic cycloaliphatic epoxy resin insulation material was prepared in an analogous manner as described in Example 1. The surface was then sand-blasted and cleaned from any dust. The hydrophobic additive (i.e., a cyclic dimethylsiloxane with an average of 6 to 8 dimethylsiloxy-units), was then added to the surface. The insulation material was then heated to 80° C. to improve migration of the hydrophobic additive over the surface of the material and then cooled back to room temperature. The hydrophobic additive within the epoxy also dispersed over the structured surface. The resulting surface had a surface contact angle to distilled water of greater than 140°. The composition of the hydrophobic cycloaliphatic epoxy resin insulation material is given in Table 2

TABLE 2

| Components | phr |
|---|---|
| Huntsman CY 5622 (resin) | 100 |
| Huntsman HY1235 (hardener) | 82 |
| Huntsman DY062 (catalyst) | 0.54 |
| Huntsman DW9134 (pigment, TiO₂) | 2.7 |
| Quarzwerke W 12EST (filler) | 344 |

Araldite® CY 5622: Hydrophobic cycloaliphatic epoxy resin (Huntsman) containing a liquid polydimethylsiloxane.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. Surface modified electrical insulation system, comprising:
a hardened or cured synthetic polymer composition which contains a synthetic polymer having at least one of an electrically insulating thermoplastic polymer and an electrically insulating duroplastic polymer, and which contains at least one filler material having at least one of an inorganic oxide, an inorganic hydroxide and an inorganic oxyhydroxide, the at least one filler material being present in the insulation system in an amount within a range of about 60% to 80% by weight calculated to a total weight of the insulation system; and
a surface formed as a structured surface with micro-scale and nano-scale features, said structured surface being covered with a liquid hydrophobic compound.

2. Electrical insulation system according to claim 1, wherein said liquid hydrophobic compound covering the structured surface of the electrical insulation system is a liquid organopolysiloxane.

3. Electrical insulation system according to claim 1, wherein said liquid hydrophobic compound covering the structured surface of the electrical insulation system is a self-assembled monolayer (SAM) composed from at least one amphiphilic compound.

4. Electrical insulation system according to claim 1, wherein said liquid hydrophobic compound covering the structured surface of the electrical insulation system is a self-assembled monolayer (SAM) composed from at least one amphiphilic compound, wherein said self-assembled monolayer (SAM) is additionally covered with a liquid hydrophobic compound which is a liquid organopolysiloxane.

5. Electrical insulation system according to claim 1 wherein the synthetic polymer is selected from polymers being used in electrical insulator compositions.

6. Electrical insulation system according to claim 5, wherein the synthetic polymer is a cycloaliphatic epoxy resin composition.

7. Electrical insulation system according to claim 1, wherein the filler material is selected from filler materials which have a structured surface after sand-blasting.

8. Electrical insulation system according to claim 7, wherein the filler material has a minimum SiO₂-content of about 95-98% by weight.

9. Electrical insulation system according to claim 1, wherein the filler is present in the synthetic polymer composition within a range of about 60% by weight to about 80% by weight, calculated to the total weight of the synthetic polymer.

10. Electrical insulation system according to claim 1, wherein the filler has an average grain size within a range of 1 μm up to 3 mm, or a selected mixture of such average grain sizes.

11. Electrical insulation system according to claim 1, wherein the liquid hydrophobic compound is a cyclic organopolysiloxane which is composed of units of a chemical formula —[Si(R)(R)O]—, which form a ring, wherein each substituent R, independent of one another, denotes a linear, branched or cyclic alkyl or phenyl, an alkyl residue having 1 to 8 carbon atoms, optionally substituted by chlorine and/or fluorine.

12. Electrical insulation system according to claim 11, wherein R is phenyl, (C₁-C₄)-alkyl optionally substituted with phenyl, 3,3,3-trifluoropropyl, monofluoromethyl, difluoromethyl, trifluoromethyl, or unsubstituted (C₁-C₄)-alkyl.

13. Electrical insulation system according to claim 1, wherein the liquid hydrophobic compound is a low molecular oligomeric organopolysiloxane which is composed of units of a chemical formula —[Si(R)(R)O]—, which are end-stopped by terminal endgroups of a formula —OSi(R)₃—, wherein each R, independent of one another, denotes a linear, branched or cyclic alkyl or phenyl, an alkyl residue having 1 to 8 carbon atoms, optionally substituted by chlorine or fluorine.

14. Electrical insulation system according to claim 1, wherein the liquid hydrophobic compound is incorporated into a bulk of the electrical insulator system in an amount within a range of 0.1% to 5% by weight, calculated to a total weight of the insulation system.

15. Electrical insulation system according to claim 1, wherein the liquid hydrophobic compound is incorporated into a bulk of the electrical insulator system, and the structured surface is treated with the liquid hydrophobic compound.

16. Electrical insulation system according to claim 1, wherein the liquid hydrophobic compound is incorporated into a bulk of the electrical insulator system, and the structured surface is covered with a self-assembled monolayer composed from at least one amphiphilic compound.

17. Electrical insulation system according to claim 3, wherein the self-assembled monolayer is grown from solution or from gas-phase.

18. Electrical insulation system according to claim 17, wherein the self-assembled monolayer is a silane-based self-assembled monolayer obtained from alkyltrichlorosilanes.

19. Method of producing a surface modified electrical insulation system, comprising:
(i) providing a hardened or cured synthetic polymer composition including at least one filler;
(ii) treating a surface of the electrical insulation system so that a structured surface is formed with micro-scale and nano-scale features; and
(iii) covering said structured surface with a liquid hydrophobic compound, or with a self-assembled monolayer (SAM) composed from at least one amphiphilic compound; or with a self-assembled monolayer (SAM) composed from at least one amphiphilic compound combined with a liquid hydrophobic compound.

20. Method according to claim 19, comprising:
configuring the surface modified electrical insulation system for a power transmission and distribution application.

21. An electrical article having a surface modified electrical insulation system, comprising:
a hardened or cured synthetic polymer composition which contains a synthetic polymer having at least one of an electrically insulating thermoplastic polymer and an electrically insulating duroplastic polymer, and which contains at least one filler material having at least one of an inorganic oxide, an inorganic hydroxide and an inorganic oxyhydroxide, the at least one filler material being present in the insulation system in an amount within a range of about 60% to 80% by weight calculated to a total weight of the insulation system; and
a surface formed as a structured surface with micro-scale and nano-scale features, said structured surface being covered with a liquid hydrophobic compound.

22. Electrical insulation system according to claim 1, wherein said liquid hydrophobic compound is at least one of cyclic organopolysiloxanes and low molecular weight oligomeric organopolysiloxanes.

23. Electrical insulation system according to claim 4, wherein said liquid hydrophobic compound covering the self-assembled monolayer is at least one of cyclic organopolysiloxanes and low molecular weight oligomeric organopolysiloxanes.

24. Electrical insulation system according to claim 5, wherein the synthetic polymer is a polyester or a duroplastic polymer.

25. Electrical insulation system according to claim 24, wherein the synthetic polymer is a poly(methyl-methacrylate), a poly(alkylacrylonitrile), a polyurethane or an epoxy resin composition.

26. Electrical insulation system according to claim 7, wherein the filler material is selected from the group of filler materials consisting of silica, quartz, known silicates, aluminium oxide, aluminium trihydrate and titanium oxide.

27. Electrical insulation system according to claim 7, wherein the filler material has a minimum SiO₂-content of about 96-98% by weight.

28. Electrical insulation system according to claim 1, wherein the filler has an average grain size within a range of sizes of 10 μm to 100 μm, or a selected mixture of such average grain sizes.

29. Electrical insulation system according to claim 1, wherein the liquid hydrophobic compound is incorporated into a bulk of the electrical insulator system in an amount within a range of about 1% weight, calculated to a total weight of the insulation system.

30. Electrical insulation system according to claim 17, wherein the self-assembled monolayer is octadecyltrichlorosilane.

31. Method according to claim 19, wherein the treating of the surface comprises:
sand-blasting the surface of the insulation until substantially all the micro and nano-scale features have been formed.
